(19) United States
(12) Patent Application Publication
(10) Pub. No.: US 2014/0328576 A1
(43) Pub. Date: Nov. 6, 2014

(54) SYSTEM AND METHOD FOR CREATING DISTINCT VIDEO CONTENT PROGRAM FROM INDIVIDUAL VIDEO CONTENT CLIPS

(71) Applicant: Glen Nelson Debarros, Henderson, NV (US)

(72) Inventor: Glen Nelson Debarros, Henderson, NV (US)

(21) Appl. No.: 14/270,290

(22) Filed: May 5, 2014

Related U.S. Application Data
(60) Provisional application No. 61/854,957, filed on May 6, 2013.

(51) Int. Cl. G11B 27/031

(52) U.S. Cl. CPC G11B 27/031
USPC 386/282

(57) ABSTRACT

A system and method for creating unique video content programs using individual clips of video content. The method involves receiving electronically a plurality of individual video clips; placing the video clips in an electronic storage device; grouping the individual video clips into multiple segregated segments such that each segregated segment contains multiple, unique individual video clips; presenting the multiple, unique individual video clips on a display; responsive to selection inputs, selecting from a display one video clip from each segregated segment; and combining and displaying the selected one video clip from each segregated segment. The segregated segments are presented in the form a matrix whereby columns relate to different segments or verses of the content while rows are different versions of the segment or verse.

### CROSS-REFERENCE

This application claims priority to Patent Application No. 61/854,957 filed May 6, 2013 which is incorporated herein for all purposes.

### FIELD OF THE INVENTION

The embodiments of the present invention relate to a system and method for creating unique video content programs using individual clips of video content.

### BACKGROUND

Music videos were popularized by various television shows including MTV and VH-1. All bands were compelled to produce videos corresponding to their presumed hit songs. However, music videos and methods of making the same have become static and outdated. Today's music fans, along with the population in general, demand greater variety and dynamic options. The same applies to music artists who want to stand out and garner the attention of fans, studios and others in the music industry.

Thus, it would be advantageous to develop a system and method for creating unique video content programs using individual clips of video content. It would be further beneficial for the system and method to be easy-to-use for music artists. Other industries, including film and comedy, can benefit from the embodiments of the present invention.

### SUMMARY

One embodiment of the present invention is related to a method of developing video content comprising: creating a plurality of individual video clips; downloading said video clips to an electronic storage device; via an input device grouping said individual video clips into multiple segregated segments such that each segregated segment contains multiple, unique individual video clips; presenting said multiple, unique individual video clips on a display; via said input device selecting from a display one video clip from each segregated segment; and wherein said selected video clips are combined and displayed by a processor.

Another embodiment of the present invention is related to a method of developing video content comprising: receiving electronically a plurality of individual video clips; placing said video clips in an electronic storage device; grouping said individual video clips into multiple segregated segments such that each segregated segment contains multiple, unique individual video clips; presenting said multiple, unique individual video clips on a display; responsive to selection inputs, selecting from a display one video clip from each segregated segment; and combining and displaying said selected one video clip from each segregated segment.

Another embodiment of the present invention is related to a system comprising: a processor configured to: receive electronically a plurality of individual video clips; place said video clips in an electronic storage device; group as prescribed by a user, said individual video clips into multiple segregated segments such that each segregated segment contains multiple, unique individual video clips; present said multiple, unique individual video clips on a display; responsive to selection inputs, select from a display one video clip from each segregated segment; and combine and display said selected one video clip from each segregated segment.

Other variations, embodiments and features of the present invention will become evident from the following detailed description, drawings and claims.

### BRIEF DESCRIPTION OF THE DRAWINGS

FIG. 1 illustrates a block diagram of an electronic device of the type which may facilitate electronic embodiments of the present invention;

FIG. 2 shows a block diagram of a wireless system which may be used to facilitate remote downloads according to the embodiments of the present invention;

FIGS. 3A-3F illustrate screen shots of an application for creating unique video content according to the embodiments of the present invention;

FIG. 4 illustrates a table of possibilities according to one embodiment of the present invention; and

FIG. 5 illustrates a flow chart detailing one methodology according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the virtual, digital and online embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “computing device” and “computer” should be understood to be any one of a general purpose computer, as for example a personal computer or a laptop computer, a client computer configured for interaction with a server, a special purpose computer such as a server, or a smart phone, tablet computer, personal digital assistant or any other machine adapted for executing programmable instructions in accordance with the description thereof set forth herein.

While this detailed description focuses on music videos, the embodiments of the present invention are suitable for movies, comedy shows and other entertainment involving video content.

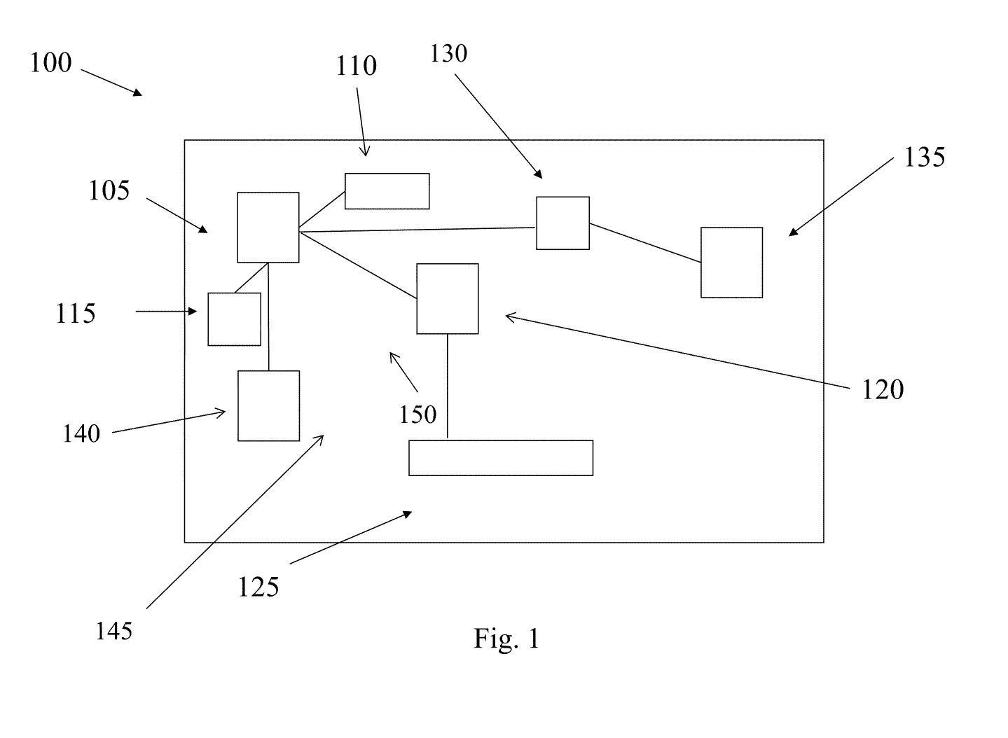

A block diagram of a computer device 100 is shown in FIG. 1. The exemplary computer device 100 may include a central processing unit (CPU) also deemed a processor 105 which controls the computer device 100 based on instructions stored in program read-only memory (ROM) 110. Program ROM 110 stores executable instructions related to the operation of the computer device 100 and which are generally permanent. CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard. In another embodiment, one or more processors may be integrated into a central server which controls multiple connected computer devices 100 based on instructions stored in program ROM 110.

A user interface 140 may respond to buttons on button panel or display incorporating touch screen technology or any other devices providing means for users to communicate with, and instruct, the computer device 100.

Those skilled in the art will recognize that the configuration and features of the electronic computer device 100 disclosed herein are exemplary and may be altered in any number of ways without impacting the embodiments of the present invention.

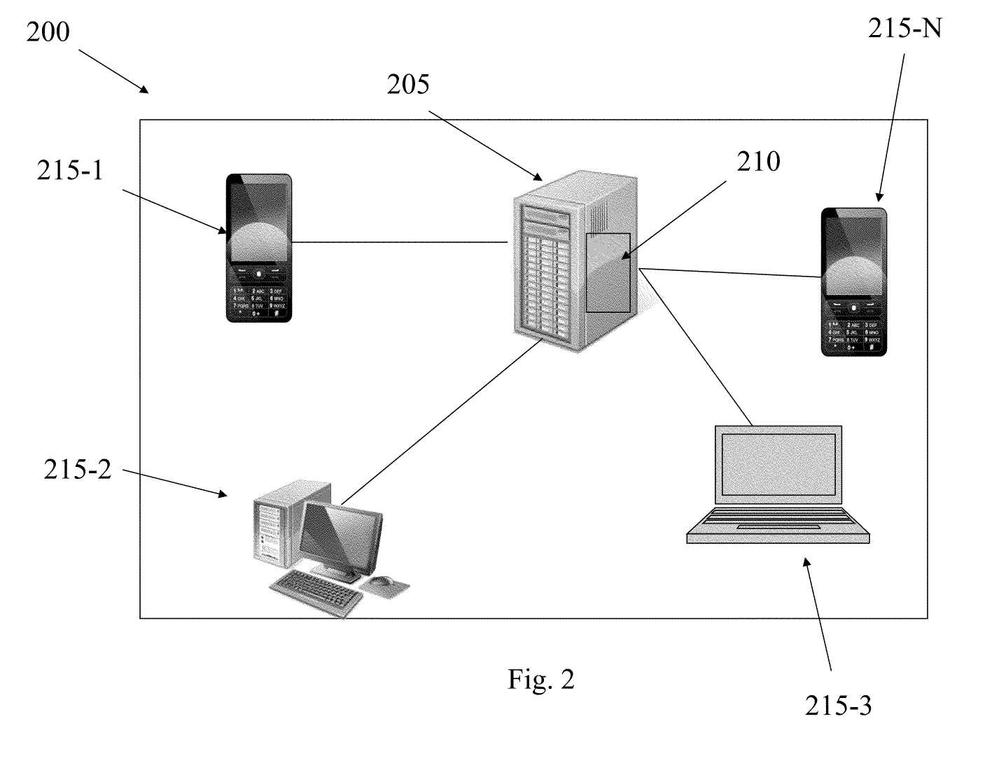

FIG. 2 shows a block diagram of a wireless system 200 which may be used to facilitate remote usage of computer devices according to the embodiments of the present invention. The wireless system 200 comprises a server 205, including one or more processors 210 running software, and remote devices 215-1 through 215-N (e.g., smart phones) configured to access said server 205 facilitating creation of video content on the remote devices 215-1 through 215-N. In one embodiment, the video content system and method according to the embodiments of the present invention may be in the form of a software application (“App”) downloadable onto smart phones, tablets or computers and useable via processing power and a user interface associated therewith. Wired connections may be used as well.

As detailed below, the embodiments of the present invention are directed to a system and method for creating unique video content programs using individual clips of video content. As described below, a matrix of video clips provides a mechanism for users to create unique video content programs.

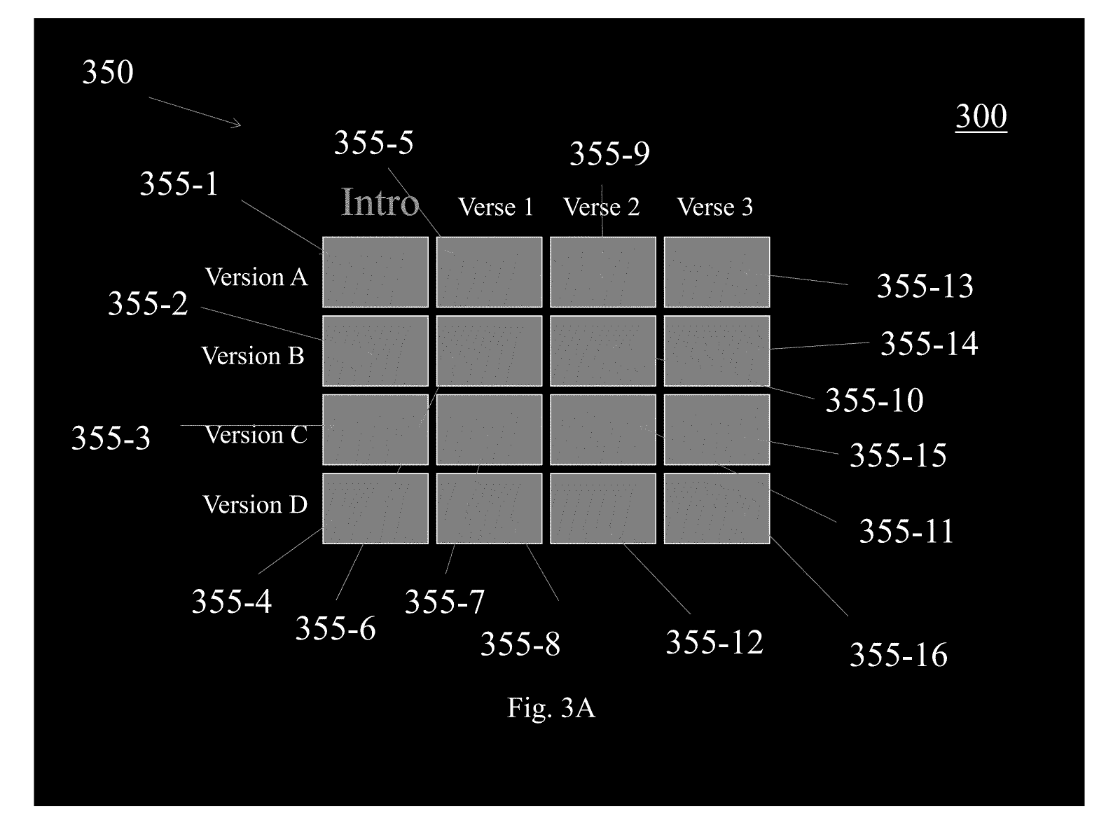

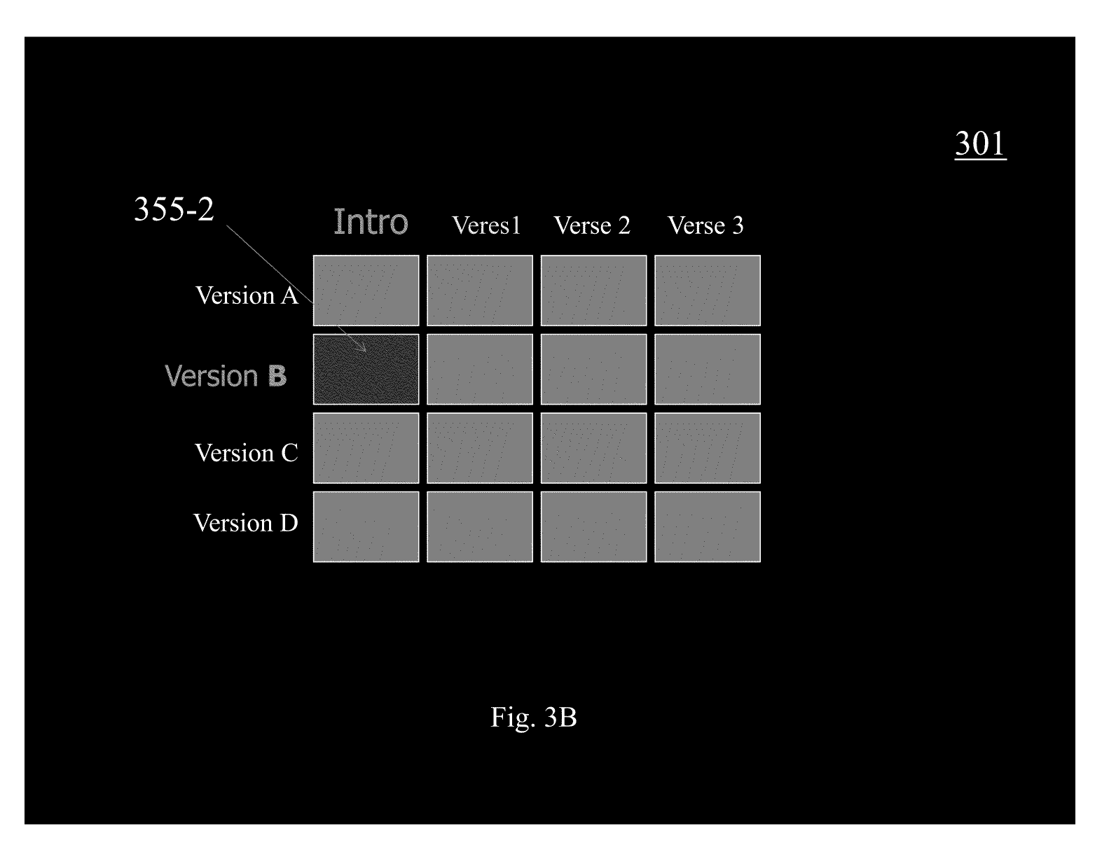

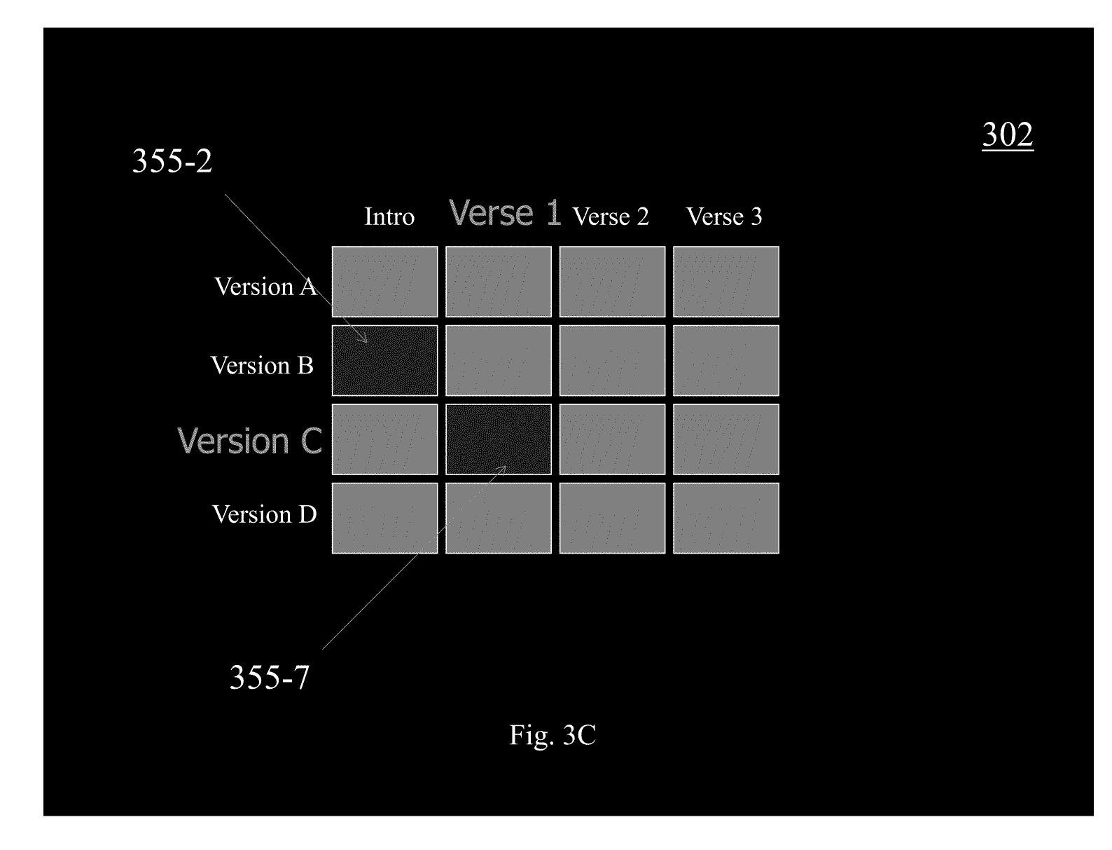

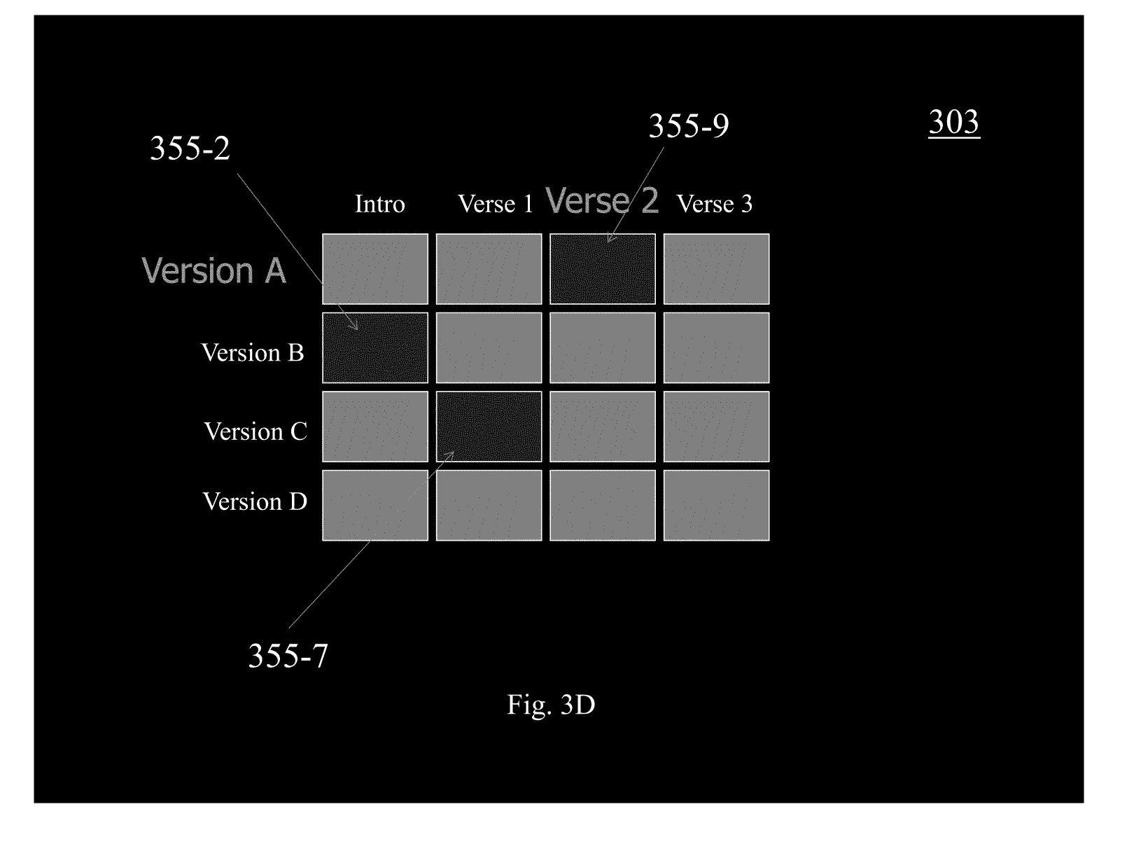

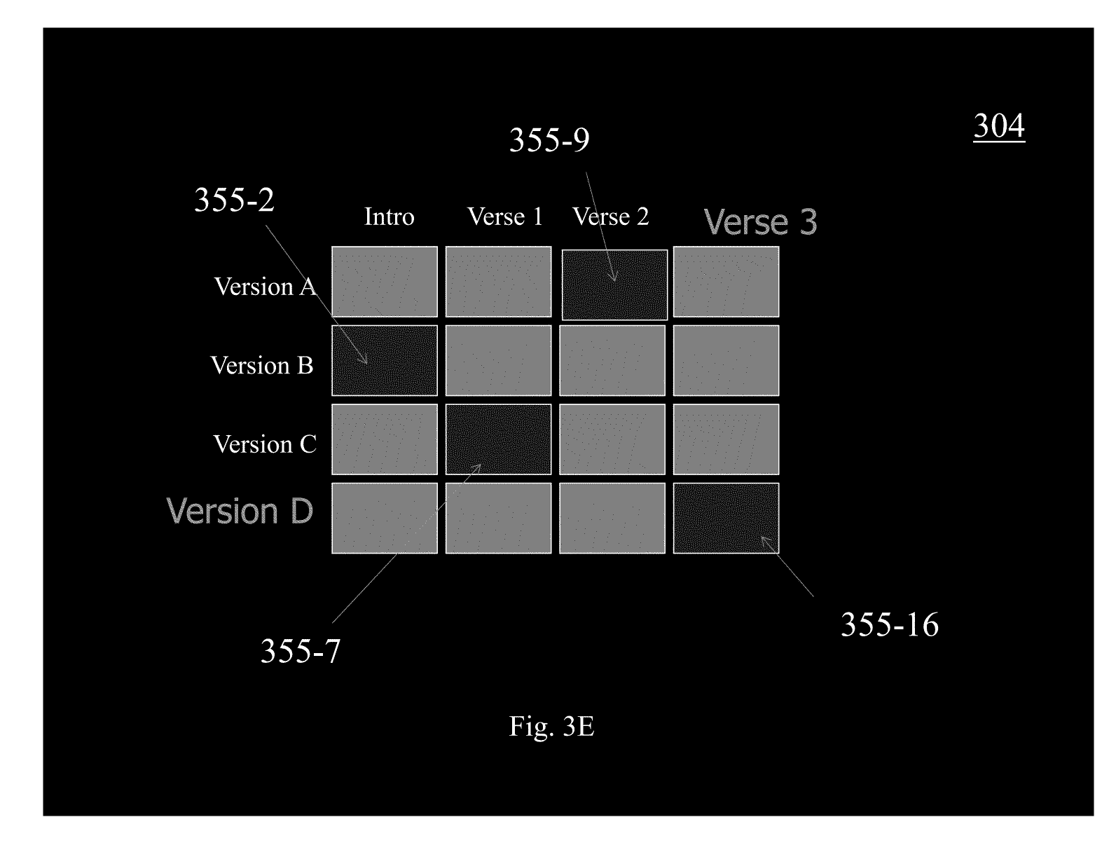

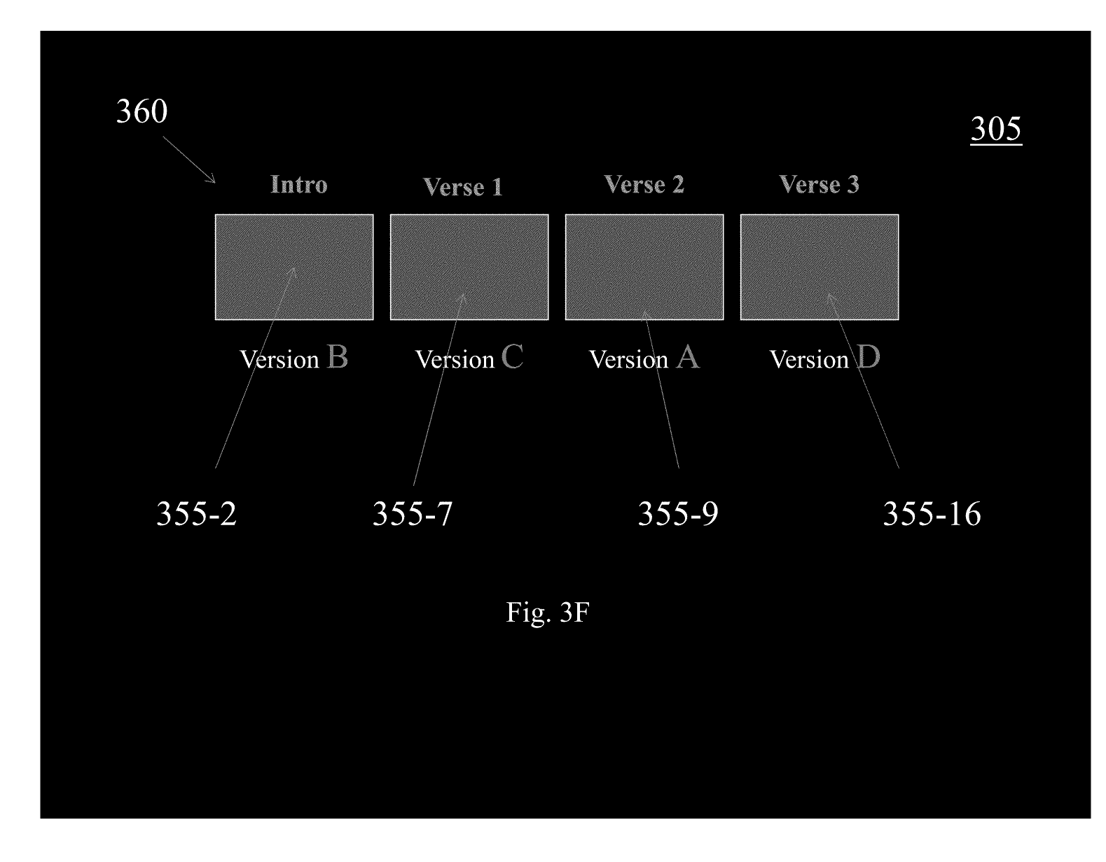

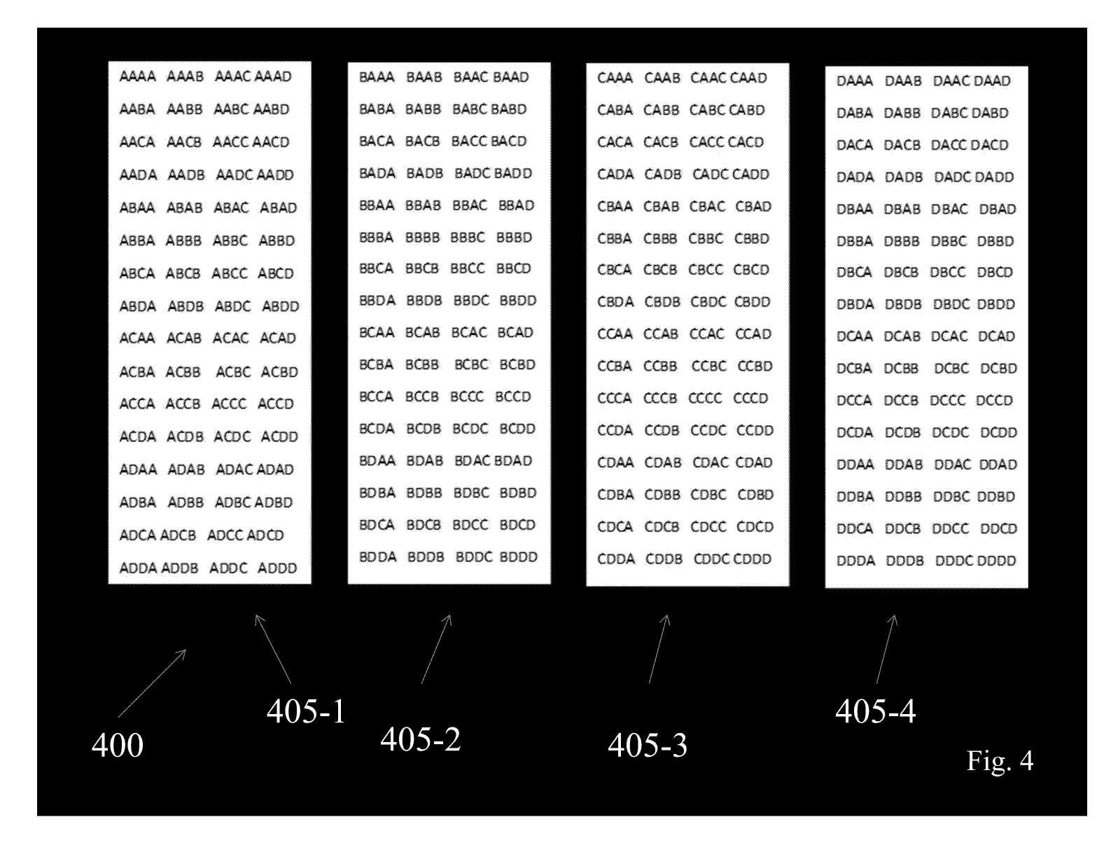

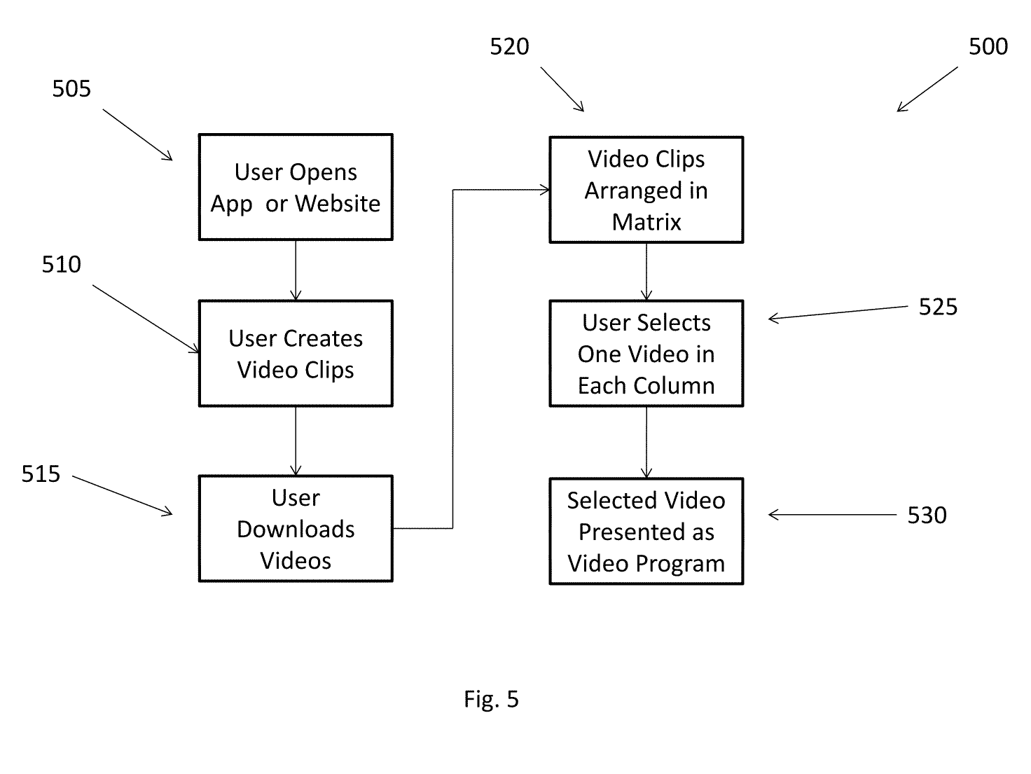

FIGS. 3A-3F show screen shots of an application for creating unique video content. Screen shot 300 shows an initial 4×4 matrix 350 formed of individual video representations, clips or snippets 355-1 through 355-16. As shown, each column identifies a different verse or segment (e.g., introduction, verse 1, verse 2 and verse 3) while each row identifies a different version (shown as versions A, B, C and D) of the verse or segment. With a 4×4 matrix there are 16 video representations, clips or snippets and 256 combinations creatable therefrom. FIG. 4 shows a list 400 of possible outcomes related to a 4×4 matrix. Columns 405-1 through 405-4 each show 64 possible outcomes. The embodiments of the present invention are suitable for larger (e.g., 5×5) or smaller matrices (e.g., 3×3). In practice, as detailed in FIG. 5, and shown in FIGS. 3B-3E, a user selects one video clip from each column. While FIGS. 3A-3F show the video representations, clips or snippets as blanks, in reality each video clip depicts the static image comprising the start of the video clip so that the user knows the content of each video clip. In one embodiment, the user may click on the video clip to play the same and double click to select it. In another embodiment, each video clip loops through the video clip within the matrix 350. Screen shot 301 shows the user has selected clip 355-2 from column 1; screen shot 302 shows the user has selected clip 355-7 from column 2; screen shot 303 shows the user has selected clip 355-9 from column 3; and screen shot 304 shows the user has selected clip 355-16. Selected clips are highlighted to permit the user to observe the selections within the matrix. FIG. 3F shows screen shot 305 depicting the selected clips 355-2, 355-7, 355-9 and 355-16 in a single row creating a video content program based on the four selected clips 355-2, 355-7, 355-9 and 355-16.

From screen shot 305 a user may watch the ensemble video and also move back to a selection screen shot by selecting one of the clips 355-2, 355-7, 355-9 and 355-16. In this manner, it is a very simple task for the user to quickly edit a video content program.

In another embodiment, a random generator is configured to select selects one video clip from each column to create a video content program. The random generator is software based and triggered by a user input. In one embodiment, individual video clips 355-1 through 355-16 are intermittingly illuminated or are otherwise highlighted as the random generator operates and until the four video clips are selected. In this manner, excitement is added to the random selection process.

FIG. 5 shows a flow chart 500 detailing a methodology for creating a video content program. At 505, a user opens an “app” or signs on to a dedicated website offering the video content solution. At 510, the user creates multiple video clips to fill the corresponding matrix as shown in FIGS. 3A-3E. A 4×4 matrix requires 16 clips comprising 4 introductions, 4 verse 1 s, 4 verse 2 s and 4 verse 3 s. At 515, the 16 clips are downloaded or otherwise transferred by the user to a storage device associated with, or in communication with, the app or website. The video clips may be generally of a uniform length (e.g., 50 seconds to 1 minute 40 seconds). In another embodiment, the lengths of the clips may be non-uniform. At 520, the 16 clips are arranged into the 4×4 matrix with the 4 introductions populating column 1, 4 number 1 verses populating column 1, 4 number 2 verses populating column 3 and 4 number 3 verses populating column 4. At 525, a user selects a video clip from each column or a random generator handles the selection. The selection process may be facilitated by a user interface including keys, mouse and/or touch screen. At 530, the selected video clips are presented as a single video content program 360 as shown in FIG. 3F. The created video content program may be stored and transmitted to others or social media outlets.

In one embodiment, the user is able to select video clips from a database of pre-created clips. That is, stock video clips may be searchable and downloadable into the matrix. Indeed, users may be able to create video content programs using stock video clips.

While the above detailed description focuses on 2 dimensional matrices (e.g., 4×4), the embodiments of the present invention are expandable into 3D applications such a 4×4×2 matrix (4 choices along x-axis, 4 choices along y-axis and 2 choices along z-axis) such that the user has more video clip choices from which to create the video content program and many more possibilities of final video content programs. With this embodiment, the 3D matrix is displayed in a rotational model allowing the user to visualize and select the video clips of the successive z-axes video clips.

The software underlying the app or website handles acceptance of the downloaded video clips, arranging the downloaded video clips into the matrix, presenting the video clips within the matrix on a display, identifying user-selected video clips from the matrix, randomly selecting video clips and creating a single video based on the selections.

Although the invention has been described in detail with reference to several embodiments, additional variations and modifications exist within the scope and spirit of the invention as described and defined in the following claims.

We claim:

1. A processor-implemented method comprising:
creating a plurality of individual video clips;
downloading said video clips to an electronic storage device;
via an input device grouping said individual video clips into multiple segregated segments such that each segregated segment contains multiple, unique individual video clips;
presenting said multiple, unique individual video clips on a display;
via said input device selecting from a display one video clip from each segregated segment; and
wherein said selected video clips are combined and displayed by a processor.

2. The method of claim 1 wherein said multiple segregated segments are arranged in a matrix with each column related to a different segment and each row related to a different version of the corresponding segment.

3. The method of claim 2 wherein said multiple segregated segments are arranged in a 4×4 matrix with each of said four columns related to a different segment and each of four rows related to a different version of the corresponding segment

4. The method of claim 2 wherein said selecting from a display one video clip from each segregated segment comprises selecting one video clip from each column of said matrix.

5. The method of claim 1 wherein said multiple segregated segments are arranged in a three dimensional matrix.

6. A processor-implemented method comprising:
receiving electronically a plurality of individual video clips;
placing said video clips in an electronic storage device;
grouping said individual video clips into multiple segregated segments such that each segregated segment contains multiple, unique individual video clips;
presenting said multiple, unique individual video clips on a display;
selecting from a display one video clip from each segregated segment; and
combining and displaying said selected one video clip from each segregated segment.

7. The method of claim 6 wherein said multiple segregated segments are arranged in a matrix with each column related to a different segment and each row related to a different version of the corresponding segment.

8. The method of claim 7 wherein said multiple segregated segments are arranged in a 4×4 matrix with each of said four columns related to a different segment and each of four rows related to a different version of the corresponding segment

9. The method of claim 7 wherein said selecting from a display one video clip from each segregated segment comprises selecting one video clip from each column of said matrix.

10. The method of claim 6 further comprising selecting from a display one video clip from each segregated segment responsive to a user input.

11. The method of claim 6 further comprising selecting from a display one video clip from each segregated segment randomly.

12. The method of claim 6 wherein said multiple segregated segments are arranged in a three dimensional matrix.

13. A system comprising:
a processor configured to:
receive electronically a plurality of individual video clips;
place said video clips in an electronic storage device;
group as prescribed by a user, said individual video clips into multiple segregated segments such that each segregated segment contains multiple, unique individual video clips;
present said multiple, unique individual video clips on a display;
select from a display one video clip from each segregated segment; and
combine and display said selected one video clip from each segregated segment.

14. The system of claim 13 wherein said multiple segregated segments are arranged in a matrix with each column related to a different segment and each row related to a different version of the corresponding segment.

15. The system of claim 14 wherein said multiple segregated segments are arranged in a 4×4 matrix with each of said four columns related to a different segment and each of four rows related to a different version of the corresponding segment

16. The system of claim 14 wherein said selecting from a display one video clip from each segregated segment comprises selecting one video clip from each column of said matrix.

17. The system of claim 13 wherein one video clip from each segregated segment is selected responsive to a user input.

18. The system of claim 13 wherein one video clip from each segregated segment is selected randomly.

19. The system of claim 13 wherein said multiple segregated segments are arranged in a three dimensional matrix.
